(19) United States
(12) Patent Application Publication
(10) Pub. No.: US 2013/0112350 A1
(43) Pub. Date: May 9, 2013

(54) RELEASE PAD FOR PLACING AN ADHESIVE-BACKED LABEL NAD A METHOD FOR ITS USE

(71) Applicant: Jacob Penniman, Lansdale, PA (US)

(72) Inventor: Jacob Penniman, Lansdale, PA (US)

(21) Appl. No.: 13/292,188

(22) Filed: Nov. 9, 2011

(51) Int. Cl. B32B 3/10; B32B 37/30; B32B 37/12

(52) U.S. Cl. 156/292; 428/114; 428/172; 428/41.8

(57) ABSTRACT

A release pad configured to receive an adhesive-backed label, wherein the release pad can comprise a debossed surface that can allow for the clean and easy removal of such labels. This release pad can be connected to any object to which attaching an adhesive-backed label is desired. In an embodiment, a pattern can be created on the debossed surface wherein the adhesion points between the pad and the label can be controlled. This pattern can be used to increase adhesion near the label's center and decrease adhesion at parts of the label farthest from its center. In an embodiment, the release pad can be attached to a reusable mailer allowing it to be used multiple times without a buildup of previously used labels.

### FIELD OF THE INVENTION

The present device is a release pad comprising a debossed surface configured to receive adhesive-backed labels. This debossed surface can allow such labels to be easily and cleanly removed from the release pad, allowing it to be used numerous times without a reduction in the release pad's ability to secure labels or any significant deterioration in the quality of its appearance. The present release pad can be attached to any object upon which an adhesive-backed label can be affixed.

### BACKGROUND

Millions of adhesive-backed labels are used by a wide range of users for numerous purposes every day. Such labels can be used as nametags, stamps, mailing labels, price tags, or any number of other information comprising devices. Most of these labels are used once, and then discarded. Often, the objects to which these labels are connected are also thrown away. For example, stamps and the envelopes to which they are connected are typically discarded after one use.

However, there are occasions when the objects to which labels are attached are not discarded. For example, many interoffice envelopes are reused many times before being discarded. Such envelopes often comprise multiple layers of labels, wherein new ones have been placed over old ones in order to create a new writing surface. These layers of labels can create a messy appearance and can become less likely to remain attached to a surface than a single label attached directly to an envelope or other object.

This system can be adequate for envelopes that are only transported within an office building, but it is not sufficient when an object must pass through the postal system or experience similar rigors. Therefore, users of reusable envelopes that must pass through the postal system often attempt to remove old labels before attaching new ones. However, most adhesive-backed labels are not designed to be removed and often tear before they can be completely removed. Steam is sometimes used to reduce the label's adhesion, but this requires a great deal of additional work making such reuse inefficient and unworkable. Others have attempted to create attachment surfaces, which do not allow the label's adhesive to adhere to it as effectively as it does to paper or similar surfaces. See Petrou, U.S. Pat. No. 5,628,858. Others have developed labels that comprise an adhesive that is more conducive to removing the label. See Dronzek, Jr., U.S. Pat. No. 7,592,057. However, such methods can be too effective in reducing the adhesion of the label, thus allowing it to detach from the attachment surface before such removal is desired.

What is needed is a release pad which can be connected to any object capable of receiving an adhesive-backed label, wherein the adhesive-backed label can adhere to the release pad well enough to pass through the postal system or to endure similar rigors but can be easily and completely removed when desired.

### SUMMARY OF THE INVENTION

It is an aspect of the present device to provide improvements in release pad devices.

The above aspect can be obtained by a release pad for receiving an adhesive-backed label, the release pad comprising: a debossed surface comprising a lower-level and an upper-level, the surface being all upper-level except for sections that are lower-level, the surface configured to receive application of the label upon which the label would contact said upper-level and would not contact said lower-level; and said debossed surface comprising: a middle strip of lower level, a first strip of lower level substantially parallel to the middle strip, a second strip of lower level substantially parallel to the middle strip, and a third strip of lower level substantially parallel to the middle strip; wherein a first width between the middle strip and the first strip is greater than a second width between the first strip and the second strip which is greater than a third width between the second strip and the third strip.

The above aspect can also be obtained by a release pad for receiving an adhesive backed label, the release pad comprising:: a debossed surface comprising a lower-level and an upper-level, the surface being all upper-level except for sections that are lower-level, the surface configured to receive application of the label upon which the label would contact said upper level and would not contact said lower level; a middle region of the debossed surface having a middle ratio of upper-level area/lower-level area; a first end region of the debossed surface having a first ratio of upper-level area/lower level area; and a second end region opposite the first end region having a second ratio of upper-level area/lower level area, wherein the middle ratio is higher than the first ratio and the middle ratio is higher than the second ratio.

The above aspect can also be obtained by a release pad for receiving an adhesive-backed label, the release pad comprising: a debossed surface comprising a lower-level and an upper-level, the surface being all upper-level except for sections that are lower-level, the surface configured to receive application of the label upon which the label would contact said upper level and would not contact said lower level; a first region located in a middle of the embossed surface and after the first region, a plurality of successive regions in the embossed surface, wherein each successive region is further away from the first region, wherein a ratio of upper-level area/lower-level area for each successive region successively increases from a previous region.

The above aspect can also be obtained by a method for using a release pad, the method comprising: providing a release pad for receiving an adhesive-backed label, the release pad comprising: a debossed surface comprising a lower-level and an upper-level, the surface being all upper-level except for sections that are lower-level, the surface configured to receive application of the label upon which the label would contact said upper level and would not contact said lower level; a middle region of the debossed surface having a middle ratio of upper-level area/lower-level area; a first end region of the debossed surface having a first ratio of upper-level area/lower level area; and a second end region opposite the first end region having a second ratio of upper-level area/lower level area, wherein the middle ratio is higher than the first ratio and the middle ratio is higher than the second ratio; providing an object capable of receiving the release pad; and attaching the release pad to the object so that the debossed surface is available to receive an adhesive-backed label.

### A BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a top view of a release pad according to an embodiment;

FIG. 2 is a cross-sectional view of a release pad as shown in FIG. 1, when cut along dashed line 100, wherein an adhesive-backed label has been affixed to the release pad, according to an embodiment.

FIG. 3 is a top view of a release pad having an alternative pattern according to an embodiment;

FIG. 4 is a top view of a backside of a reusable envelope comprising a release pad according to an embodiment;

FIG. 5 is a top view of a front side of a reusable envelope, wherein the envelope is in an open configuration according to an embodiment;

FIG. 6 is a top view of a backside of a reusable envelope comprising a release pad wherein an adhesive-backed label has been affixed to the release pad according to an embodiment;

FIG. 7 is a top view of a backside of a reusable envelope comprising a release pad wherein an adhesive-backed label has been partially removed from the release pad according to an embodiment; and

FIG. 8 is a top view of a release pad having an alternative pattern according to an embodiment.

### DETAILED DESCRIPTION

This description of the exemplary embodiments is intended to be read in connection with the accompanying drawings, which are to be considered part of the entire written description. In the description, relative terms such as “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

The inventive concept relates to a release pad that can receive and release an adhesive-backed label numerous times allowing the release pad to be reused, and to provide a release pad configured so that an adhesive-backed label can adhere to the release pad sufficiently well to pass through the postal system or to endure similar rigors, but can also be easily and completely removed when doing so is desired.

One key to providing a release pad that can allow adhesive-backed labels to be attached and removed easily and cleanly numerous times is controlling where and to what degree the label's adhesive can be allowed to adhere to the release pad. Typically, a label's entire adhesive-coated surface is placed into contact with the surface of an object to which it is being connected. This means that the only adhesion-controlling factor is the nature of the object's surface to which the label is being attached. Some materials comprise an extremely high surface energy, such as glass and metal surfaces, which allows adhesives to adhere much more strongly, making adhesive-backed labels much more difficult to remove from such surfaces. Other surfaces, such as paper and cardboard, can easily tear, making the clean removal of adhesive-backed labels more difficult for that reason. The present release pad can be comprised, at least in part, of a nylon surface, having a relatively low surface energy, which can allow for a level of adhesion that is sufficient for most purposes but not so high that the label cannot be removed or so low that the label can become detached easily.

In addition to the materials comprising the release pad, adhesion can be controlled by using an uneven surface on the release pad, to which a label can be connected. This uneven surface can comprise an upper-level, or “land areas,” to which the label's adhesive can adhere to, and a lower-level, or “span areas,” to which the label's adhesive does not adhere or fully adhere because they are recessed lower than the land areas thus preventing those portions of the label covering the span areas from physically contacting the release pad. The use of such lower-levels can prevent the label from adhering to the entire surface area of the release pad.

Another important advantage of using a release pad comprising an uneven surface with upper-levels and lower-levels is the ability to control where the label is allowed to adhere more to the release pad and where it is allowed to adhere less to the release pad. This can be important where an adhesive-backed label is of a shape that does not allow for uniform or unidirectional force to be applied throughout the label when it is being removed by pulling from one corner or side of the label. By placing more lower-level surface area in locations on the release pad where the label receives less force when being removed, or forces that are not parallel with the direction the label is being pulled, the label can adhere to the release pad less in these locations and be less likely to tear. In locations where greater force and more unidirectional force can be applied, more upper-level surface area can be utilized in order to maximize adhesion of the label to the release pad. Balancing the upper-level surfaces and lower-level surfaces can result in a connection between the label and the release pad that is sufficiently secure, yet not so secure that the label cannot be cleanly removed. For example, many mailing labels are rectangular in shape. To remove such a label, one often pulls one of its corners toward a center of the label and toward an opposite corner. However, this can result in the greatest force being applied to the center of the adhesive-backed label and the least force being applied to the outer edges of the label causing tearing of the label to result.

A feature of the present device allows for the easy and clean removal of an adhesive-backed label from a release pad when force is applied in a particular direction. In one embodiment, using a rectangular release pad and label, the pattern of the release pad can enable the label to be removed more easily when force is applied to either of two of the label's four corners and make removal more difficult when force is applied to the remaining two corners.

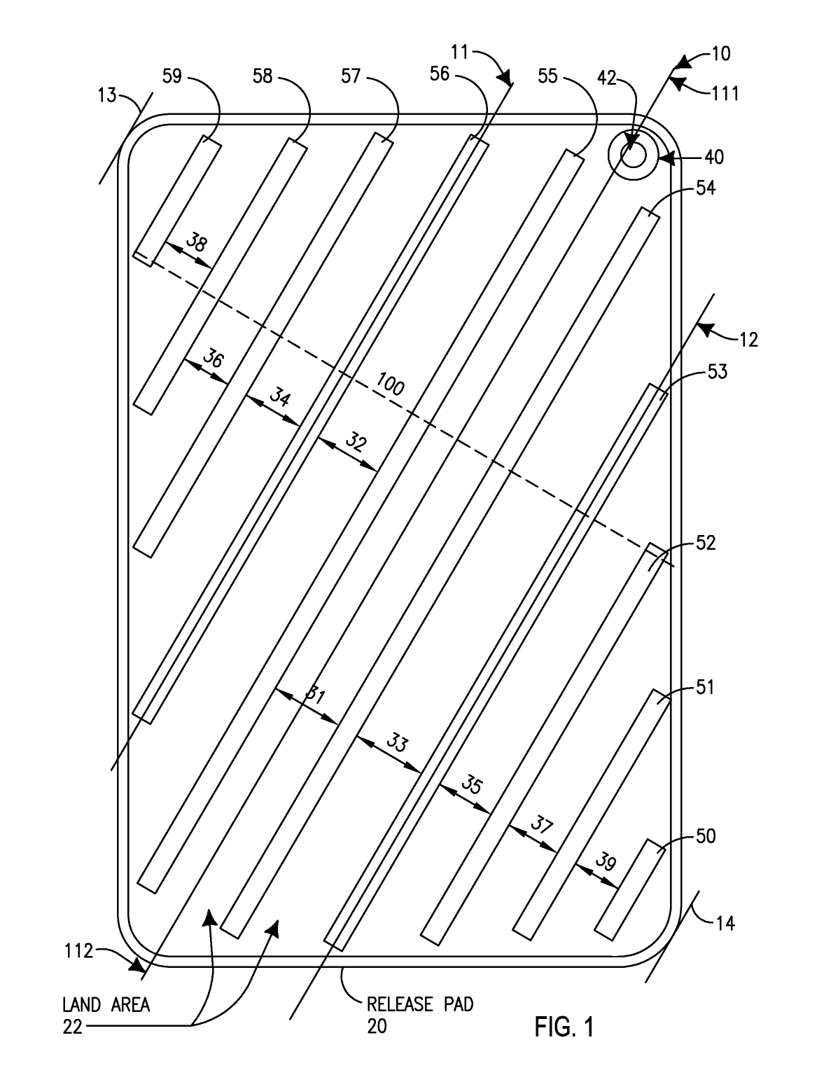

FIG. 1 is a top view of a release pad 20 according to an embodiment. Although the release pad 20 depicted in this figure is a rectangle, the release pad can be any size or shape sufficient to receive a particular adhesive-backed label. The lower-level surface areas of the release pad 20 are numbered 50 through 59 and the remaining surface areas comprising the release pad 20 are the upper-level surface areas 22.

FIG. 1 can illustrate the spacing of the lower-level or span areas 50-59 in a particular embodiment and the remaining upper-level or land area 22 comprising the release pad 20. When an adhesive-backed label (not shown) is applied to the release pad 20, it can only contact the land areas 22 and not the span areas 50-59 due both to their narrow width and the depth of each particular span area 50-59. An adhesive-backed label can bridge any particular span area 50-59 and adhere to any land area 22. In an embodiment, the spacing of the span areas 50-59 can be regressive so that land area width 31 can be greater than land area width 32, which in turn can be greater than land area width 34, which can be greater than land area width 36, which in turn can be greater than land area width 38. Similarly, starting from land area width 31, the position of span area 54 and span area 53 can determine land area width 33 as being less than land area width 31. Land area width 35 can be smaller than land area width 33, land area width 37 can be smaller than land area width 35, and land area width 39 can be smaller than land area width 37.

When viewed from a line of diagonal bisection 10 the spacing of span areas 50-59 can create a regressive amount of land area, wherein the ratio of land area to span area is at a maximum near the line of diagonal bisection 10 and decreases to a minimum at points along the surface area of the release pad that are the greatest distance from the line of diagonal bisection 10, according to an embodiment. This reduction of land area 22 at locations farthest from the line of diagonal bisection 10 can advantageously provide for the release of an adhesive device by reducing adhesion in said areas. In other words, the pad has numerous land areas between span areas, and starting with a center land area, the distance (width) between span areas decreases at each successive land area from the center land area. Thus, the center land area 31 has the largest width and the land areas on the edges 38, 39 the smallest width. The pad can be symmetrical, e.g., width 32 equals width 33, and width 34 equals width 35 and width 36 equals width 37 and width 38 equals width 39, although in another embodiment symmetricality is not required. The width of the span areas would typically be constant (as illustrated in FIG. 1), although in another embodiment this is not required.

In an embodiment, the release pad can comprise a middle strip of lower level, a first strip of lower level substantially parallel to the middle strip, a second strip of lower level substantially parallel to the middle strip, and a third strip of lower level substantially parallel to the middle strip. A first width between the middle strip and the first strip can be greater than a second width between the first strip and the second strip which can be greater than a third width between the second strip and the third strip.

In an embodiment, the release pad can comprise a middle region, located between lines 11 and 12 of the debossed surface, having a middle ratio of upper-level area/lower-level area. This embodiment can also comprise a first end region, located between lines 13 and 11 of the debossed surface, having a first ratio of upper-level area/lower level area, and a second end region opposite the first end region, located between lines 12 and 14, having a second ratio of upper-level area/lower level area. In this embodiment, the middle ratio can be higher than the first ratio and the middle ratio can be higher than the second ratio.

In an embodiment, a directional control can be possible wherein an adhesive-backed label can be peeled along a line of diagonal bisection 10 and parallel to the span areas 50-59 and land areas 22 located between these span areas 50-59. In this way, the adhesive can be sheared to start the peel and then shear continuously for the entire length of the peel. In this embodiment, the peel can begin at a first end 111 of a diagonal line of bisection 10 and end at a second end 112 of a diagonal line of bisection, or begin at the second end 112 and end at the first end 111. In this embodiment, if the adhesive-backed label is peeled at an angle perpendicular to the line of diagonal bisection 10 it would also be peeled perpendicular to lines of adhesive bond created by the label's adhesion to land areas 22 located between the span areas 50-59. In this direction, the peel can be sheared to start the peel but at the first span area, the peel is interrupted and the adhesive must be sheared again to restart the peel at the beginning of the next land area and so on. This directional control can be consequential because it can be more difficult to start and stop shear of the adhesive than it is to maintain an initial shear through the peeling of the label. In other words, in this embodiment, an adhesive-backed label can be removed more cleanly and easily when it is pulled parallel to the line of diagonal bisection 10 rather than perpendicular to the a line of diagonal bisection 10.

A user of the present release pad 20 can be instructed to begin removing an adhesive-backed label at a start area 40 comprising an enlarged span area 42 to minimize adhesion at that point, in one embodiment. In FIG. 1, the start area 40 can be located at the first end 111 of the line of diagonal bisection 10, according to an embodiment. Although it is not depicted in FIG. 1, the start area 40 can also be located at the second end 112 of the line of diagonal bisection 10 or one start area 40 could be located at the first end 111 of the line of diagonal bisection 10 and a second start area (not visible) could be located at the second end 112.

In an embodiment, the regression of the spacing of land areas 50 through 59 can be calculated by the formula:

Land Area width (step n)=Land Area Center width * (1−r)̂n

Where n is the number of the step, and r is the rate. In FIG. 1, land area center width 31 can be 0.75 inches and r can be 0.12 inches. Therefore, land area width step 1 can be represented by land area width 33 in FIG. 1. Land area width 33 can be calculated as=(0.75 inches) * (1-0.12 inches)̂1 meaning that land area width 33 (step 1) can be 0.66 inches. Using this same formula, land area width 35 can be 0.58 inches, and land area width 37 can be approximately 0.51 inches, according to an embodiment. Different values of r and different land area center widths can be employed to obtain optimal results when using different materials to construct the release pad 20 or different adhesives.

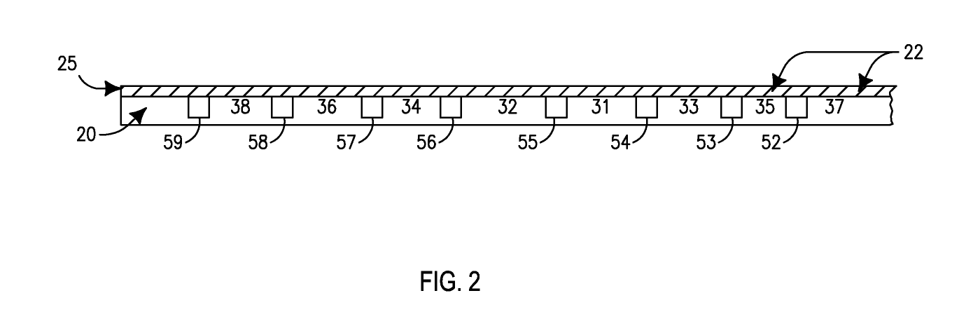

FIG. 2 is a cross-sectional view of a release pad 20 when cut along dashed line 100, wherein an adhesive-backed label 25 has been affixed to the release pad 20, according to an embodiment. Not all of the span areas shown in FIG. 1 are present in FIG. 2 as line 100 does not intersect each of the span areas 50-59 pictured in FIG. 1.

An adhesive-backed label 25 can be attached to the release pad 20 so that the span areas 52 thru 59 are not placed into contact with the label 25. Each of the land area widths 31 thru 38 can be placed into contact with the adhesive-backed label 25. The bridging of the span areas 52 thru 59 by the adhesive-backed label 25 can easily be seen in FIG. 2. In an embodiment the lower-level span areas, 52 thru 59, can be located 1 to 3 millimeters below the upper-level land areas 22.

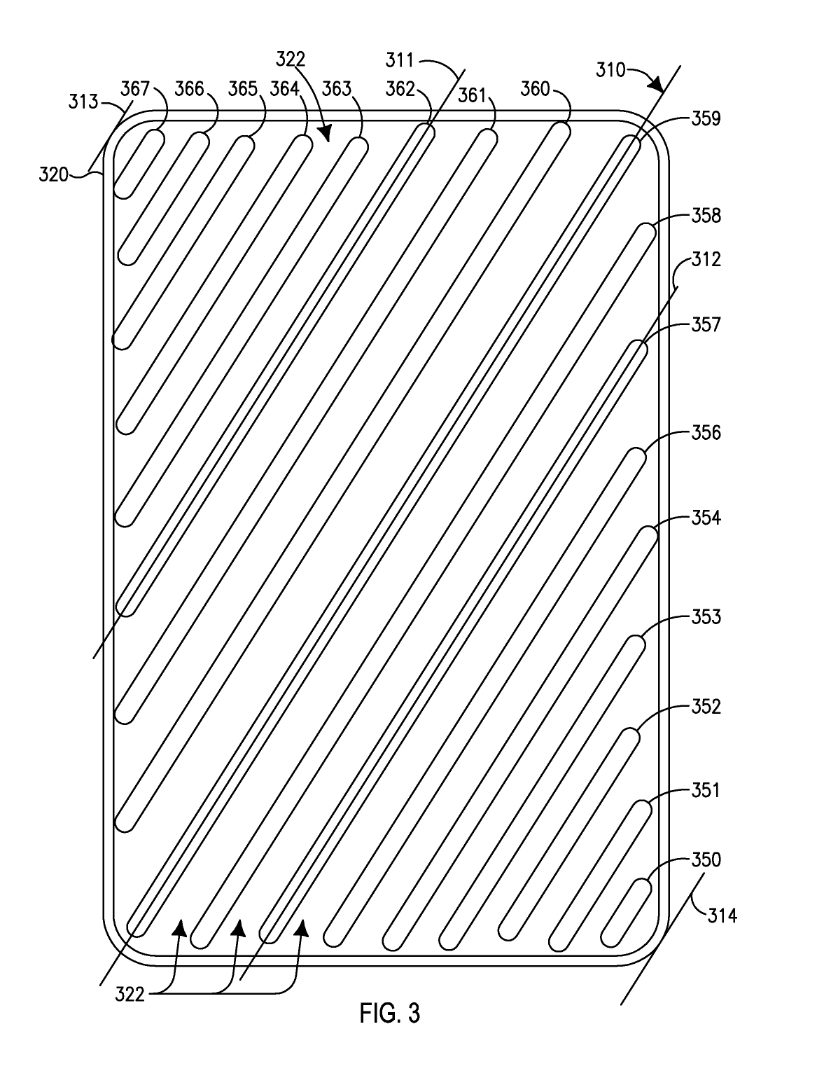

FIG. 3 is a top view of a release pad 300 having an alternative pattern according to an embodiment. This embodiment differs from the release pad 20 in FIG. 1 only in that it contains more steps. The land area 322 widths comprising FIG. 2 can continue to decrease as their distance from the line of diagonal bisection 310 increases. Other embodiments could include regular or random shapes or lines, which could be placed in such a way to control land and span ratios and thus the adhesion of an adhesive-backed label.

In and embodiment, the release pad 300 can comprise a middle region, located between lines 311 and 312 of the debossed surface, having a middle ratio of upper-level area/lower-level area. This embodiment can also comprise a first end region, located between lines 313 and 311 of the debossed surface, having a first ratio of upper-level area/lower level area, and a second end region opposite the first end region, located between lines 312 and 314, having a second ratio of upper-level area/lower level area. In this embodiment, the middle ratio can be higher than the first ratio and the middle ratio can be higher than the second ratio.

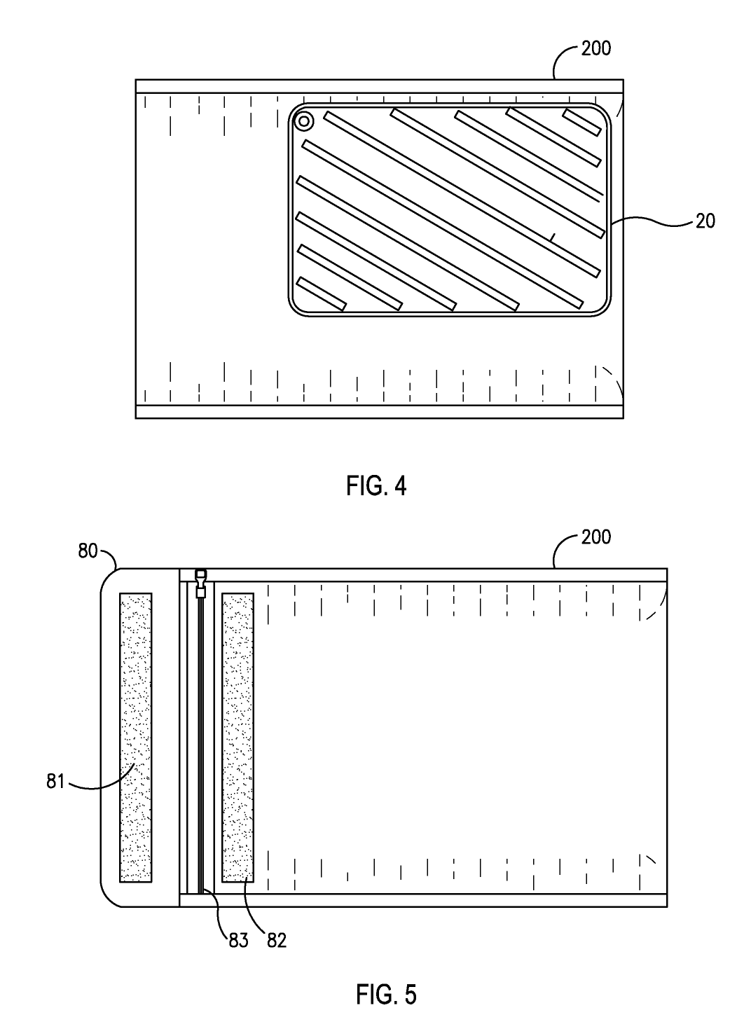

FIG. 4 is a top view of the backside of a reusable envelope 200 comprising a release pad 20 according to an embodiment.

The release pad 20 can be comprised of a nylon fabric or any other suitable fabric comprising surface adhesion properties being sufficiently robust to withstand multiple trips through the postal system. In one embodiment, this release pad 20 can also comprise a polyvinyl chloride (PVC) backing, which can be configured to facilitate the attachment of the release pad 20 to a reusable envelope 200 or other types of reusable shipping containers. This PVC backing can be welded to a reusable envelope 200 having an exterior surface, which is also comprised of PVC material. Although this welding process can be an extremely effective technique for connecting the release pad 20 to a reusable envelope 200 or similar package, gluing, stitching, riveting or any other suitable attachment techniques can also be used for this purpose. In this manner, labels (not visible) can be easily removed from the envelope 200 and new labels can be attached to the envelope 200 by using the release pad 20 to affix the labels onto it. Thus, typically labels should not be directly affixed directly onto the envelope (without using the release pad 20).

FIG. 5 is a top view of the front side of a reusable envelope 200, in an open configuration, comprising a release pad (not visible) according to an embodiment. In an embodiment, the reusable envelope 200 can be constructed from a single length of PVC, which can be folded off center to create a flap 80. The material can be welded along three sides to create a pouch that can be closed with a zipper 83 and hook and loop closure comprising hook section 81 and loop section 82. When flap 80 is closed, the reusable envelope 200 can be secured by the zipper 83 and the hook and loop closure. The reusable envelope 200 can be configured to receive items sized in a range from a page of paper to a hardcover book (not visible). The reusable envelope 200 can be constructed from a durable material combined with a release pad for a label to be affixed. In an embodiment, the outer surface of the envelope 200 that is not covered by the release pad can be constructed of one or more materials that discourage the application of additional adhesive items such as shipping and transit stickers (not visible). In a preferred embodiment, adhesive devices such as labels and stickers can function well on the release pad while they will not adhere or function well on the balance of the envelope. In one embodiment, the reusable envelope 200 can be constructed from a tear resistant and durable material such as 13 oz. PVC vinyl coated polyester fabric. This material can be sufficiently durable to withstand passing through the delivery process numerous times without yielding or compromising the items within the pouch. A PVC material can also be desirable for this use because it can be sealed to itself through the use of radio frequency (RF) welding. The release pad can be made from a second piece of material and can be made from a different material from the material forming the reusable envelope 200. In one embodiment, this second material can be 70 Denier Taffeta Nylon fabric with 0.30 mm PVC backing, which can allow this material to be welded to the reusable envelope 200. This Nylon fabric can provide a surface that can securely maintain adhesion of an adhesive-backed label (not visible). Both the 13 oz. PVC vinyl coated polyester fabric and the 70 Denier Taffeta Nylon fabric with 0.30 mm PVC backing can be obtained from Topvaluefabrics.com. The adhesive-backed label can be constructed from many types of cardstock comprising an adhesive coating on one side. In an embodiment, the adhesive-backed label can be comprised of 2 Mil Polyprint PET with a coating of TP170 adhesive on one side. This material can have a high tear resistance, heat and UV resistance, and TP170 adhesive can have a good initial tack, high shear, and high ultimate adhesion. The materials for constructing the label can be obtained from Technicote, Inc. Of course, other suitable materials can be used to construct the components described herein.

The release pad can be RF welded to the envelope. The welding can be performed to produce a debossed pattern on the surface of the release pad. The areas of the release pad fabric that are welded to the envelope can create depressed span areas and the areas not welded can create raised land areas. This process can create a debossed release pad and the RF welding can be employed to create a pattern of span and land areas.

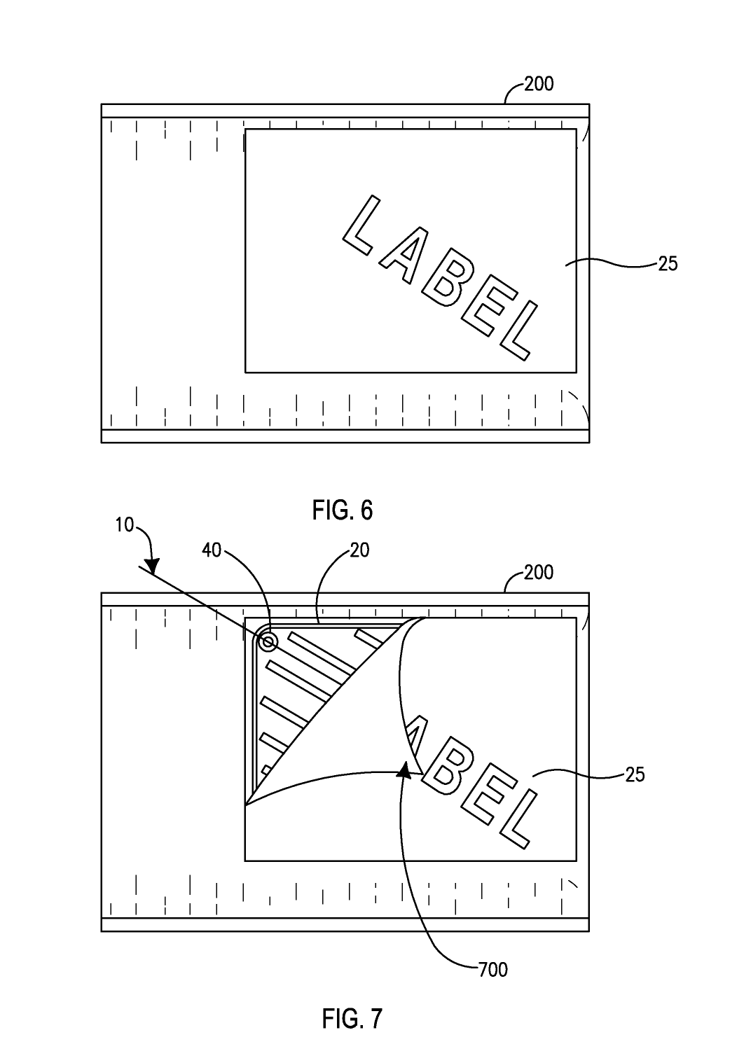

FIG. 6 is a top view of a backside of a reusable envelope 200 comprising a release pad (not visible) wherein an adhesive-backed label 25 has been affixed to the release pad (not visible) according to an embodiment.

Although the release pad and adhesive-backed label 25 are shown in use with a reusable envelope 200, the present release pad can be used on any item to which an adhesive-backed label can be connected.

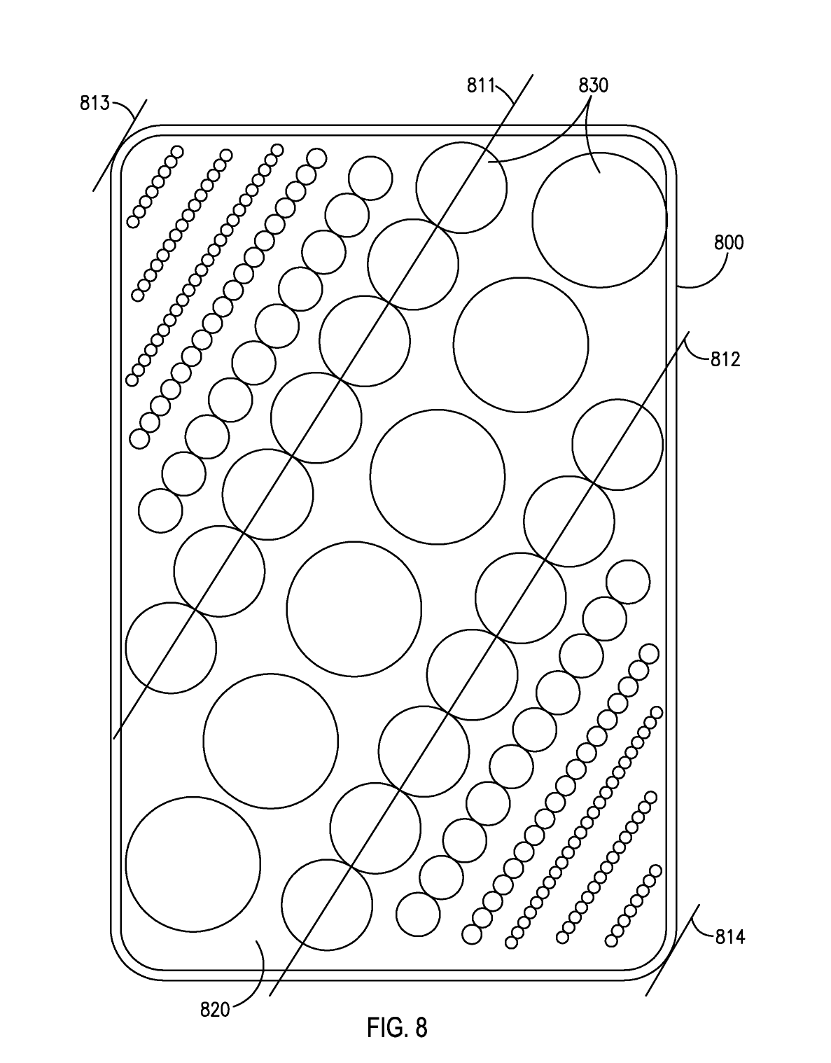

FIG. 7 is a top view of a backside of a reusable envelope 200 comprising a release pad 20 wherein an adhesive-backed label 25 has been partially removed from the release pad 20 according to an embodiment.

This figure shows how an adhesive-backed label 25 can be removed from a release pad 20 by pulling an upper left-hand corner 700 of the label 25 along a diagonal line of bisection 10. The removal of this upper left-hand corner 700 of the adhesive-backed label 25 can be facilitated by a start area 40.

FIG. 8 is a top view of a release pad 800 having an alternative debossing pattern according to an embodiment.

In an embodiment, the release pad 800 can comprise circles 830 of various sizes. The surface areas of these circles 830 can comprise the upper-level surface areas of the release pad 800 and the remaining surface area 820 can comprise the lower-level surface areas of the release pad 800. Although the circles 830 in this figure are depicted in a linear arrangement, they could also be located in a random pattern. Additionally, any shape other than circles could be used to comprise a similar release pad 820.

In and embodiment, the release pad 800 can comprise a middle region, located between lines 811 and 812 of the debossed surface, having a middle ratio of upper-level area/lower-level area. This embodiment can also comprise a first end region, located between lines 813 and 811 of the debossed surface, having a first ratio of upper-level area/lower level area, and a second end region opposite the first end region, located between lines 812 and 814, having a second ratio of upper-level area/lower level area. In this embodiment, the middle ratio can be higher than the first ratio and the middle ratio can be higher than the second ratio.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A release pad for receiving an adhesive-backed label, the release pad comprising:
a debossed surface comprising a lower-level and an upper-level, the surface being all upper-level except for sections that are lower-level, the surface configured to receive application of the label upon which the label would contact said upper-level and would not contact said lower-level; and
said debossed surface comprising:
a middle strip of lower level, a first strip of lower level substantially parallel to the middle strip, a second strip of lower level substantially parallel to the middle strip, and a third strip of lower level substantially parallel to the middle strip;
wherein a first width between the middle strip and the first strip is greater than a second width between the first strip and the second strip which is greater than a third width between the second strip and the third strip.

2. A release pad as described in claim 1 wherein the debossed surface comprises a start area comprising only a lower-level at one corner of the release pad.

3. A release pad as described in claim 1 wherein the debossed surface is comprised at least in part of a nylon material.

4. A release pad as described in claim 1 wherein the release pad comprises a front debossed surface and a back surface, wherein the back surface is configured to be affixed to the surface of an object.

5. A release pad as described in claim 4 wherein the back surface is comprised of a polyvinyl chloride material capable of being radio frequency welded to objects also comprising a polyvinyl chloride material.

6. A release pad as described in claim 4 wherein the back surface comprises an adhesive.

7. A release pad for receiving an adhesive-backed label, the release pad comprising:
a debossed surface comprising a lower-level and an upper-level, the surface being all upper-level except for sections that are lower-level, the surface configured to receive application of the label upon which the label would contact said upper level and would not contact said lower level;
a middle region of the debossed surface having a middle ratio of upper-level area/lower-level area;
a first end region of the debossed surface having a first ratio of upper-level area/lower level area; and
a second end region opposite the first end region having a second ratio of upper-level area/lower level area,
wherein the middle ratio is higher than the first ratio and the middle ratio is higher than the second ratio.

8. A release pad as described in claim 7 wherein the debossed surface comprises a start area comprising only a lower-level at one corner of the release pad.

9. A release pad as described in claim 7 wherein the debossed surface is comprised at least in part of a nylon material.

10. A release pad as described in claim 7 wherein the release pad comprises a front debossed surface and a back surface, wherein the back surface is configured to be affixed to the surface of an object.

11. A release pad as described in claim 10 wherein the back surface is comprised of a polyvinyl chloride material capable of being radio frequency welded to objects also comprising a polyvinyl chloride material.

12. A release pad as described in claim 10 wherein the back surface comprises an adhesive.

13. A release pad for receiving an adhesive-backed label, the release pad comprising:
a debossed surface comprising a lower-level and an upper-level, the surface being all upper-level except for sections that are lower-level, the surface configured to receive application of the label upon which the label would contact said upper level and would not contact said lower level;
a first region located in a middle of the embossed surface and after the first region, a plurality of successive regions in the embossed surface, wherein each successive region is further away from the first region, wherein a ratio of upper-level area/lower-level area for each successive region successively increases from a previous region.

14. A release pad as described in claim 13 wherein the debossed surface comprises a start area comprising only a lower-level at one corner of the release pad.

15. A release pad as described in claim 13 wherein the debossed surface is comprised at least in part of a nylon material.

16. A release pad as described in claim 13 wherein the release pad comprises a front debossed surface and a back surface, wherein the back surface is configured to be affixed to the surface of an object.

17. A release pad as described in claim 16 wherein the back surface is comprised of a polyvinyl chloride material capable of being radio frequency welded to objects also comprising a polyvinyl chloride material.

18. A release pad as described in claim 16 wherein the back surface comprises an adhesive.

19. A release pad as described in claim 1 wherein the release pad is configured to be attached to a reusable container.

20. A release pad as described in claim 7 wherein the release pad is configured to be attached to a reusable container.

21. A release pad as described in claim 13 wherein the release pad is configured to be attached to a reusable container.

22. A reusable mailer as described in claim 19 wherein the reusable container is an envelope.

23. A reusable mailer as described in claim 20 wherein the reusable container is an envelope.

24. A reusable mailer as described in claim 21 wherein the reusable container is an envelope.

25. A reusable mailer as described in claim 19 wherein the reusable container is a box.

26. A reusable mailer as described in claim 20 wherein the reusable container is a box.

27. A reusable mailer as described in claim 21 wherein the reusable container is a box.

28. A reusable mailer as described in claim 22 wherein the envelope comprises a reusable closure mechanism.

29. A reusable mailer as described in claim 23 wherein the envelope comprises a reusable closure mechanism.

30. A reusable mailer as described in claim 24 wherein the envelope comprises a reusable closure mechanism.

31. A release pad as described in claim 1 wherein the middle strip is located along a line of diagonal bisection.

32. A release pad as described in claim 7 wherein the middle region is located along a line of diagonal bisection.

33. A release pad as described in claim 13 wherein the first region is located along a line of diagonal bisection.

34. A method for using a release pad, the method comprising:
providing a release pad for receiving an adhesive-backed label, the release pad comprising: a debossed surface comprising a lower-level and an upper-level, the surface being all upper-level except for sections that are lower-level, the surface configured to receive application of the label upon which the label would contact said upper level and would not contact said lower level; a middle region of the debossed surface having a middle ratio of upper-level area/lower-level area; a first end region of the debossed surface having a first ratio of upper-level area/lower level area; and a second end region opposite the first end region having a second ratio of upper-level area/lower level area, wherein the middle ratio is higher than the first ratio and the middle ratio is higher than the second ratio;
providing an object capable of receiving the release pad; and
attaching the release pad to the object so that the debossed surface is available to receive an adhesive-backed label.
